(19) United States
(12) Patent Application Publication
(10) Pub. No.: US 2020/0094617 A1
(43) Pub. Date: Mar. 26, 2020

(54) MECANUM WHEEL AND ROBOT PROVIDED WITH MECANUM WHEEL

(71) Applicant: SZ DJI TECHNOLOGY CO., LTD., Shenzhen (CN)

(72) Inventors: Zhenxu WANG, Shenzhen (CN); Chuanlu ZUO, Shenzhen (CN); Hongsheng HUANG, Shenzhen (CN)

(21) Appl. No.: 16/699,328

(22) Filed: Nov. 29, 2019

Related U.S. Application Data
(63) Continuation of application No. PCT/CN2017/090952, filed on Jun. 29, 2017.

(30) Foreign Application Priority Data
May 31, 2017 (CN) 201720619487.0

(51) Int. Cl. B60B 19/00; B60B 19/12; B60B 9/10

(52) U.S. Cl. CPC B60B 19/003; B25J 5/007; B60B 9/10; B60B 19/125

(57) ABSTRACT

The present disclosure provides a Mecanum wheel. The Mecanum wheel includes a spoke, a hub, and a plurality of rollers disposed on an outer edge of the spoke. The spoke includes a receiving space to house the hub. The Mecanum wheel further includes a cushioning member, one end of the cushioning member being connected to the spoke, and the other end of the cushioning member being connected to the hub. In response to receiving an impact force, the cushioning member deforms to cause a displacement change of the hub relative to the spoke.

### CROSS-REFERENCE TO RELATED APPLICATION

This application is a continuation application of International Application No. PCT/CN2017/090952, filed on Jun. 29, 2017, the entire contents of which are incorporated herein by reference.

### TECHNICAL FIELD

The present disclosure relates to the field of omnidirectional moving wheels and, more particularly, to Mecanum wheels and a robot with Mecanum wheels.

### BACKGROUND

With its flexibility and diversity, the Mecanum wheel is a widely used omnidirectional wheel in the field of omnidirectional intelligent mobile devices (e.g., robots). However, in robotics or other applications such as robots and unmanned vehicles, the wheels are often subjected to impacts that damage the overall structure, hence, reducing the wheel lifespan.

### SUMMARY

One aspect of the present disclosure provides a Mecanum wheel. The Mecanum wheel includes a spoke, a hub, and a plurality of rollers disposed on an outer edge of the spoke. The spoke includes a receiving space to house the hub. The Mecanum wheel further includes a cushioning member, one end of the cushioning member being connected to the spoke, and the other end of the cushioning member being connected to the hub. In response to receiving an impact force, the cushioning member deforms to cause a displacement change of the hub relative to the spoke.

In some embodiments, the cushioning member includes a plurality of elastic parts disposed in a circumferential direction.

In some embodiments, the elastics members each includes a curved portion that is configured to deform after the elastic members receive the impact force.

In some embodiments, the elastic members each includes two or more curved portions, and the two or more curve portions are curved in opposite bending directions.

In some embodiments, the plurality of elastic members are evenly distributed between the spoke and the hub.

In some embodiments, the body of each elastic member is a sheet structure.

In some embodiments, the plane of the sheet structure is parallel to the centerline of the hub, or the plane of the sheet structure is perpendicular to the centerline of the hub.

In some embodiments, the elastic members each includes two or more layers that are disposed along the centerline direction of the hub.

In some embodiments, the cushioning member, the hub, and the spoke are integrated into one piece.

In some embodiments, the spoke includes a first spoke, and a second spoke disposed opposite to the first spoke; the hub includes a first hub and a second hub; the plurality of rollers are disposed between the first spoke and the second spoke; the second hub is recessed towards the first hub to form the receiving space such that the first hub and the second hub are both disposed on a same side of an intermediate plane equidistant from the first spoke and the second spoke; and the receiving space is configured to house a motor

Another aspect of the present disclosure provides a robot. The robot includes a body and a suspension. A Mecanum wheel is connected to the body through the suspension. The Mecanum wheel includes a spoke, a hub, and a plurality of rollers disposed on an outer edge of the spoke. The spoke includes a receiving space to house the hub. The Mecanum wheel further includes a cushioning member, one end of the cushioning member being connected to the spoke, and the other end of the cushioning member being connected to the hub. In response to receiving an impact force, the cushioning member deforms to cause a displacement change of the hub relative to the spoke.

The embodiments of the present disclosure eliminates the impact (especially the frontal impact) applied to the Mecanum wheel by adding a deformable cushioning member at the joining surface of the spoke and the roller to provide shock absorption and reduce the impact on the overall structure, thus extending the lifespan of the Mecanum wheel, making it especially suitable for use in harsh conditions (such as collision, drop, bump, etc.).

It is to be understood that both the foregoing general description and the following detailed description are exemplary and explanatory and are intended to provide further explanation of the present disclosure instead of limiting the present disclosure.

### BRIEF DESCRIPTION OF THE DRAWINGS

For a more complete understanding of the present disclosure, and the advantages thereof, reference is now made to the following descriptions to be taken in conjunction with the accompanying drawings. The accompanying drawings in the following description show merely some embodiments of the present invention, and a person of ordinary skill in the art may still derive other drawings from these accompanying drawings without creative efforts.

FIG. 1 is a schematic illustrating the structure of a Mecanum wheel according to an embodiment of the present disclosure;

FIG. 2 is a schematic illustrating the structure of the Mecanum wheel according to another embodiment of the present disclosure;

FIG. 3 is a schematic illustrating the structure of the Mecanum wheel according to yet another embodiment of the present disclosure;

FIG. 4 is a schematic illustrating the structure of the Mecanum wheel according to still another embodiment of the present disclosure;

FIG. 5 is a schematic illustrating the structure of the Mecanum wheel in another direction according to an embodiment of the present disclosure;

FIG. 6 is a perspective view of the Mecanum wheel according to an embodiment of the present disclosure;

FIG. 7 is a perspective view of the Mecanum wheel according to another embodiment of the present disclosure;

FIG. 8 is a perspective view of the Mecanum wheel according to yet another embodiment of the present disclosure;

FIG. 9 is a perspective view of the Mecanum wheel according to still another embodiment of the present disclosure; and

FIG. 10 is a perspective view of a robot according to an embodiment of the present disclosure.

It should be noted that the reference numerals shown in the drawings are described as follows:
100: body;
200: Mecanum wheel;
300: motor;
400: suspension;
500: imaging device;
1: spoke;
11: first spoke;
12: second spoke;
13: storage space;
131: receiving space;
2: hub;
21: first hub;
211: first through hole;
22: second hub;
221: second through hole;
3: roller;
4: cushioning member;
41: elastic member;
42: outer connecting portion;
43: inner connecting portion;
51: first supporting member;
511: first connecting portion;
512: first reinforcing portion;
52: second supporting member;
521: second connecting portion;
522: second reinforcing portion;
6: fastener;
7: fixing member.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Reference will now be made in detail to exemplary embodiments, examples of which are illustrated in the accompanying drawings. The following description refers to the accompanying drawings in which the same numbers in different drawings represent the same or similar elements unless otherwise indicated. The implementations set forth in the following description of exemplary embodiments do not represent all implementations consistent with the disclosure. Instead, they are merely examples of apparatuses and methods consistent with aspects related to the disclosure as recited in the appended claims.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

The terms used herein are for the purpose of illustrating the embodiments only, rather than limiting the present disclosure. The terms “a,” “said” and “the” of singular forms used in the present description and the attached claims are also intended to include their plural forms, unless otherwise clearly specified in the context. It can also be appreciated that the term “and/or” as used herein refers to any or all possible combinations of one or more associated items as listed.

It can be appreciated that, while the terms “first,” “second,” “third” and so on may be used herein to describe various information, such information is not limited to these terms, which are only used to distinguish between different information of the same category. For example, the first information can also be referred to as the second information, and similarly the second information can also be referred to as the first information, without departing from the scope of the present disclosure. Depending on the context, the term “if” as used herein can be interpreted as “when,” “while,” or “in response to determining.”

Hereinafter, the Mecanum wheel 200 and the robot with the Mecanum wheels 200 in the present disclosure will be described with reference to the accompanying drawings It should be noted that embodiments and all element limitations in all embodiments may be combined in the case of no conflicts. The present invention will be described in detail in the following combining figures and embodiments.

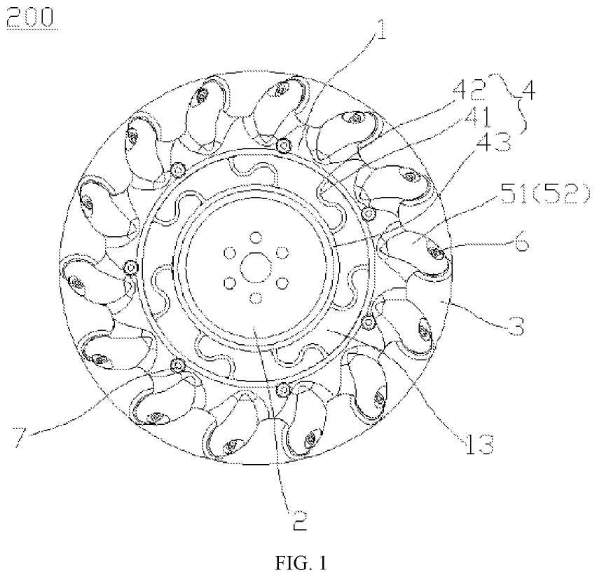

Referring to FIG. 1 to FIG. 4, the present disclosure provides a Mecanum wheel 200. The Mecanum wheel may include a spoke 1, a hub 2, a roller 3, and a cushioning member 4. The spoke 1 may include a storage space 13 to storing the hub 2. The roller 3 may include a plurality of rollers 3 disposed on the outer edge of the spoke 1 to increase the flexibility and diversity of the wheel motion. Further, the plurality of rollers 3 may be evenly distributed on the outer edge of the spoke 1 to ensure the uniformity of the circumferential impact force on the spoke 1.

One end of the cushioning member 4 may be connected to the spoke 1, and the other end of the cushioning member 4 may be connected to the hub 2. The cushioning member 4 may deform after being impacted, causing the displacement of the hub 2 relative to the spoke 1 (i.e., the center position of the hub 2 may change within the storage space 13).

In the embodiments of the present disclosure, by adding the deformable cushioning member 4 at the joining surface of the spoke 1 and the roller 3 to provide shock absorption and reduce the loss of impact on the overall structure, the lifespan of the Mecanum wheel 200 may be extended, making it especially suitable for use in harsh conditions (such as collision, drop, bump, etc.).

In some embodiments, the cushioning member 4 may be formed using a cushioning medium such as sponge or rubber. In the present embodiment, a cushioning layer (a sponge layer or a rubber layer) may be disposed on the joining surface of the spoke 1 and the hub 2. The thickness and size of the cushioning layer may vary depending on the cushioning effect, product size, etc. In one embodiment, to achieve a better cushioning effect, the entire outer circumference of the hub 2 may be wrapped with the cushioning layer. If the Mecanum wheel 200 is impacted by force, the cushioning layer may deform to allow the displacement of the hub 2 relative to the spoke 1, thus absorbing the shock.

In some embodiment, the cushioning member 4 may be a shock absorber. More specifically, a plurality of shock absorbers may be circumferentially disposed at the joining portion between the spoke 1 and the hub 2, and the spoke 1 and the hub 2 may be connects by the plurality of shock absorbers. In some embodiments, the plurality of shock absorbers may be evenly distributed on the circumference of the hub 2 for a better shock absorbing effect.

In some embodiments, the cushioning member 4 may be a formed of a tough material (for example, a ductile steel sheet) or the like to achieve the shock absorbing effect while ensuring the strength of the Mecanum wheel 200.

To further illustrate the embodiments of the present disclosure, hereinafter, the structure of the cushioning member 4 will be explained, and the material of the cushioning member 4 will be a tough material as an example.

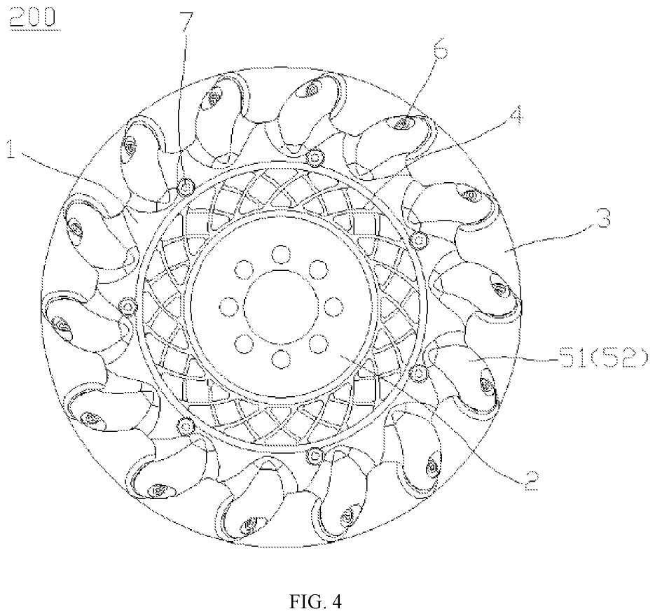

Referring to FIG. 1 to FIG. 4, the cushioning member 4 may include a plurality of elastic members 41 disposed in a circumferential direction. The elastic members 41 may deform after being impacted by the force to allow the displacement of the hub 2 relative to the spoke 1, thereby cancelling the impact force in many directions to achieve a better shock absorbing effect. Referring to FIG. 4, in some embodiments, the elastic member 41 may include a curved portion (not shown), which may deform after the elastic member 41 is impacted by force. In the present embodiment, the elastic member 41 is similar to an arc. Further, the bending direction of the curved portions of the plurality of elastic members 41 may change. For example, the intervals of the bending direction of the curved portions of the plurality of elastic members 41 may change to achieve a better cushioning effect. Referring to FIG. 1 to FIG. 3, in some embodiments, the elastic members 41 may include two or more curved portions to increase the amount of bendable deformation to achieve a better cushioning effect. In the present embodiment, the shape of the elastic member 41 may be similar to an “S” shape or a wave shape. Further, the two or more curved portions on each elastic member 41 may have opposite bending directions. For example, the bending direction of the two or more curved portions on each elastic member 41 may change between the interval, or, the bending direction of the two or more curved portions on each elastic member 41 may be different, so each elastic member 41 may deform more to achieve a better cushioning effect. In one embodiment, each elastic member 41 may have two curved portions having different bending directions.

In some embodiments, the plurality of elastic members may be evenly distributed between the spoke 1 and the hub 2 to offset the impact force from different directions.

Referring to FIG. 4, in some embodiments, the elastic member 41 may have two or more layers. The two or more layers of elastic members 41 may be disposed along the centerline direction of the hub 2. By increasing the joining surface between the hub 2 and the elastic member 41, and the joining surface between the spoke 1 and the elastic member 41, a better shock absorbing effect, an increase in the supporting force of the hub 2 on the spoke 1, and an increase on the strength of the Mecanum wheel 200 may be achieved. Referring to FIG. 4 again, the two or more layers of elastic members 41 may be cross-distributed to increase the supporting force of the cushioning member 4. Further, the inclination direction of the two or more layers of elastic members 41 between the spoke 1 and the hub 2 may be different.

In some embodiment, the cushioning member 4, the hub 2, and the spoke 1 may be integrated into one piece to further improve the cushioning effect and achieve a better shock absorbing effect.

Referring to FIG. 1 to FIG. 4, in some embodiments, the cushioning member 4 may further include an outer connecting portion 42 to connect to spoke 1, and an inner connecting portion 43 to connect to the hub 2. In the present embodiment, the outer connecting portion 42 and the inner connecting portion 43 are both annular and coaxially disposed, and the inner connecting portion 43 is sleeved inside the outer connecting portion 42. Further, one end of the elastic member 41 may be connected to the outer connecting portion 42, and the other end of the elastic member 41 may be connected to the inner connecting portion 43. Furthermore, when securing the elastic member 41, the outer surface of the outer connecting portion 42 may be secured to the inside of the spoke 1 by means of a snap, a plug, etc., and the corresponding securing mean in the hub 2 may be disposed in the inner annular surface of the inner connecting portion 43. Referring to FIG. 1, to further secure the elastic member 41, after the outer annular surface of the outer connecting portion 42 is secured to the inside of the spoke 1 by means of a snap, a plug, etc., a plurality of fixing members 7 (such as screws) may be used to connect the outer connecting portion 42 and the spoke 1 to further strengthened the connection.

Further, the structure of the elastic members 41 may be determined based on its strength, cushioning effect, weight, etc. In some embodiments, the body of the elastic member may be a sheet-like structure. Since the sheet-like structure provides higher toughness and amount of deformation with a lighter weight, the sheet-like structure may be used as the body of the elastic member 41, and the cushioning effect and the supporting effect of the elastic member 41 may be improved while reducing the weight of the product. It should be noted that in the present embodiment, the sheet-like structure refers to a sheet having a thickness less than a predetermined thickness (e.g., 2 cm), and the bending direction of the bent portions is along the thickness direction of the sheet.

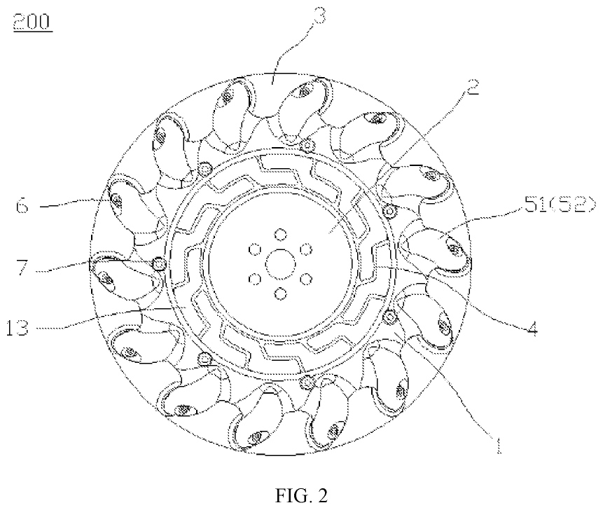

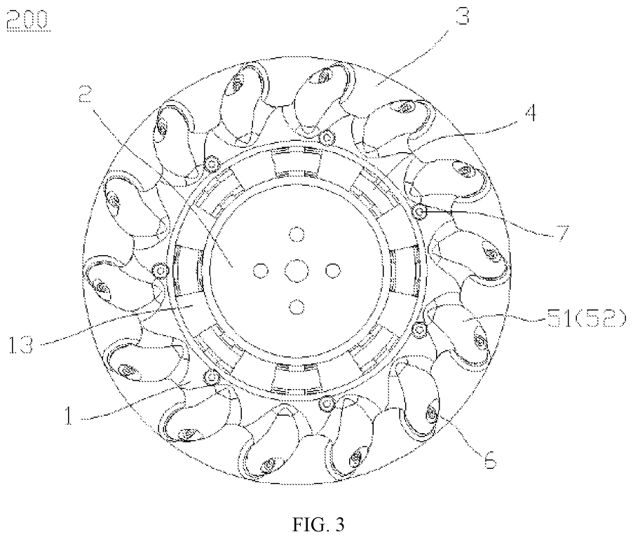

The distribution of the elastic members 41 may also be arranged based on different cushioning and supporting effects. In some embodiments, the plane of sheet-like structure may be parallel to the centerline of the hub 2 (i.e., the central axis of the hub 2). In some embodiments, referring to FIG. 3, the plane of sheet-like structure may be perpendicular to the centerline of the hub 2. Referring to FIG. 1, FIG. 2, and FIG. 4, in some embodiments, the centerline of the hub 2 may be located on the plane of the sheet-like structure, or the centerline of the hub 2 may intersect the plan of the sheet-like structure. In particular, the plane in which the sheet-like structure is located refers to a plane tangential to the curved portion of the elastic members 41. In addition, it should be noted that the plane of the sheet-like structure in the embodiment may be close to parallel or perpendicular to the centerline of the hub 2 due to manufacturing errors, installation errors, etc. Further, to increase the connecting strength at the joint between the elastic members 41 and the hub 2, and the elastic member 41 and the spoke 1, the two ends of the elastic members 41 may be slightly larger than the center portion of the elastic members 41.

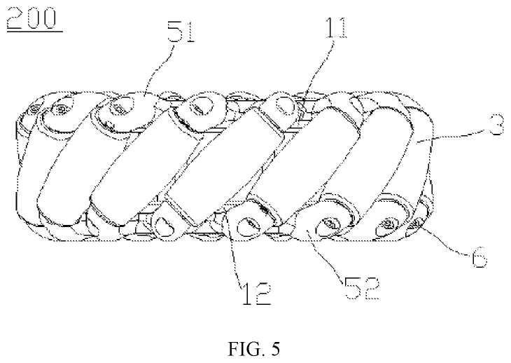

Referring to FIG. 5 to FIG. 9, the spoke 1 may include a first spoke 11 and a second spoke 12 opposite to the first spoke 11, and the hub 2 may include a first hub 21 and a second hub 22.

Further, the roller 3 may be disposed between the first spoke 11 and the second spoke 12. More specifically, the roller 3 may be at a predetermined angle with respect to the first spoke 11 and the second spoke 12, and the roller 3 in the present embodiment is disposed obliquely between the first spoke 11 and the second spoke 12, thereby increasing the movement flexibility and diversity of the roller 3. Furthermore, the predetermined angles may be 15°, 30°, 45°, etc.

In the present embodiment, the structures of the first spoke 11 and the second spoke 12 may be identical, and the first spoke 11 and the second spoke 12 may be connected to form an annular structure. Further, the roller 3 may be disposed on the outer annular surface of the annular structure, and the first hub 21 and the second hub 22 are coupled to the inner annular surface of the annular structure to support the first spoke 11 and the second spoke 12.

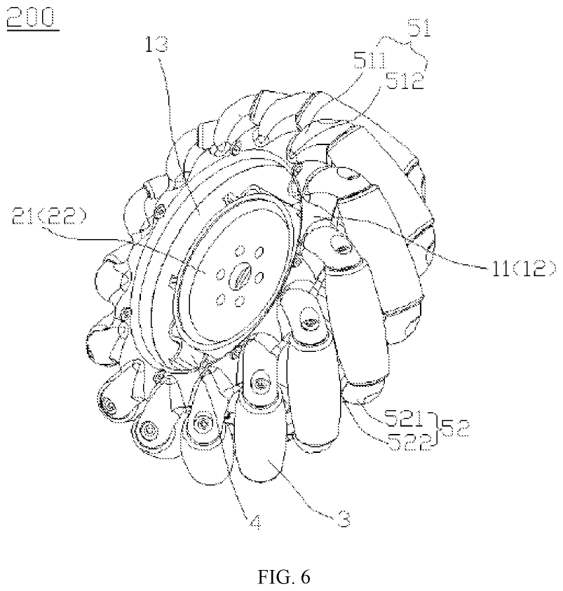

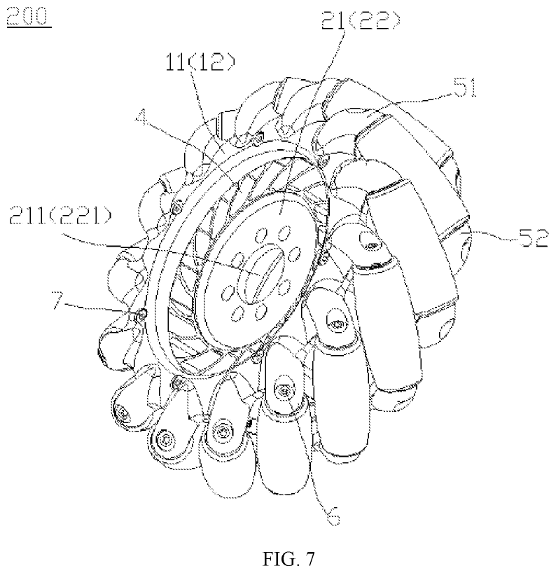

Referring to FIG. 6 and FIG. 7, in some embodiments, the first hub 21 and the second hub 22 may be disposed on both sides of an intermediate plane that is equidistant from the first spoke 11 and the second spoke 12.

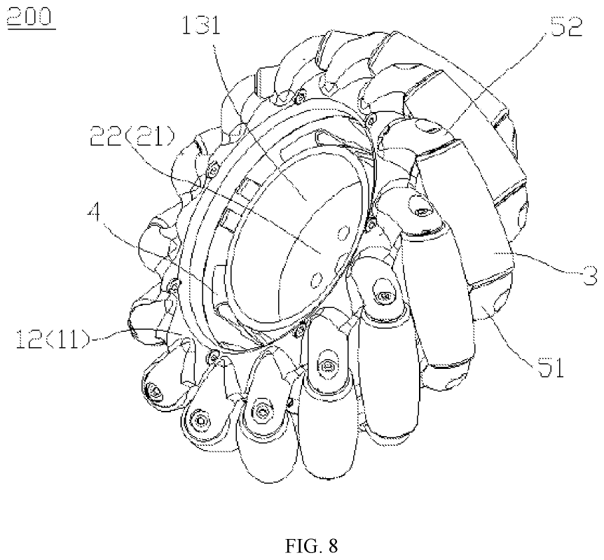

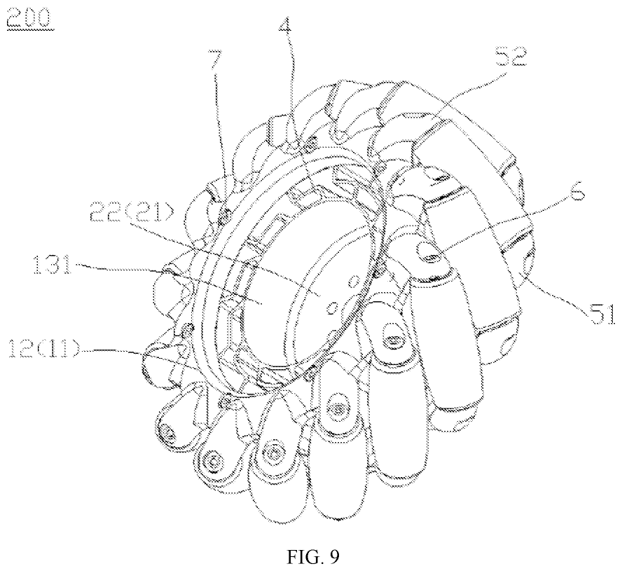

Referring to FIG. 8 and FIG. 9, in some embodiments, the second hub 22 may be recessed towards the first hub 21 to form a receiving space 131, so the first hub 21 and the second hub 22 may be disposed on the same side of the intermediate plane that is equidistant from the first spoke 11 and the second spoke 12 (i.e., the first hub 21 and the second hub 22 may be offset and disposed in the storage space 13), and the receiving space 131 may be used to house a motor 300. In this embodiment, the receiving space 131 is a part of the storage space 13.

In some embodiments, the recess of the second hub 22 in the direction facing towards the first hub 21 means that a cavity may be formed on the second hub 22 towards the first hub 21, and the cavity may be the receiving space 131. Further, the cavity may be located in the middle of the hub 22.

In some embodiments, the recess of the second hub 22 in the direction facing towards the first hub 21 means that the second hub 22 as a whole may move towards the first hub 21 to form the receiving space 131. In the present embodiment, by changing the installation or formation position of the second hub 22, the receiving space 131 may be formed without changing the structure of the second hub 22, which is easier to implement. In addition, in the present embodiment, to increase the size of the receiving space 131, the first hub 21 may be disposed on the same plane as the first spoke 11, and the second hub 22 as a whole may be moved towards the first hub 21, such that the second hub 22 may be as close to the first spoke 11 as possible, thereby increasing the receiving space 131.

Of course, in the present embodiment, the first hub 21 and the second hub 22 are interchangeable, that is, the first hub 21 may be recessed towards the second hub 22 to form the receiving space 131, so the first hub 21 and the second hub 22 may be disposed on the same side of the intermediate plane that is equidistant from the first spoke 11 and the second spoke 12.

By moving one of the hubs 2 on either side of the intermediate plane (the plane that is equidistant from the first spoke 11 and the second spoke 12) towards each other, or moving one of the hubs 2 on both sides of the intermediate plane towards the cavity so both hubs 2 may be located on the same side of the intermediate plane (that is, the two hubs 2 are disposed in an offset fashion), the receiving space 131 may be formed to house the motor 300, so the structure may be more compact and the size of the product may be reduced.

The following embodiment will further illustrate the structure of the Mecanum wheel 200 of the present disclosure using the example of the second hub 22 being recessed towards the first hub 21.

In some embodiments, to further enlarge the receiving space 131, the first hub 21 may be disposed on the same plane as the first spoke 11, and the second hub 22 and the first hub 21 may be attached. In the present embodiment, the plane where the first hub 21 and the first spoke 11 are disposed is a plane parallel to the intermediate plane between the first spoke 11 and the second spoke 12. In the present embodiment, by disposing the first hub 21 and the first spoke 11 in the same plane, the connection area between the first hub 21 and the first spoke may be large enough to ensure that the first hub 21 may provide the maximum supporting force. At the same time, the first hub 21 may be place as far away from the intermediate plane as possible, thereby increasing the movable distance of the second hub 22. Further, the second hub 22 and the first hub 21 may be attached such that the receiving space 131 may be large enough to accommodate different types of motors 300.

Referring to FIG. 6 to FIG. 9, the first hub 21 may include a first through hole 211, and the second hub 22 may include a second through hole 221, where the first through hole 211 and the second through hole 221 may be coaxially disposed to mount and secure the motor 300, and transmit the power of the motor 300 to the first hub 21 and the second hub 22. More specifically, an output shaft of the motor 300 may be inserted into the first through hole 211 and the second through hole 221.

In some embodiments, to increase the strength and supporting effect, the first hub 21 and the second hub 22 may both be solid structures so the Mecanum wheel 200 may be better adapt to harsher environment.

In addition, in some embodiments, to simplify the design and the structure, the first hub 21 and the second hub 22 may be integrated into one piece. In some other embodiments, the first hub 21 and the second hub 22 may be two separate components.

Referring to FIG. 1 to FIG. 9, a first supporting member 51 may be disposed on the outer edge of the first spoke 11, and a second supporting member 52 may be disposed on the outer edge of the second spoke 12. One end of the roller 3 may be connected to the first supporting member 51, and the other end of the roller 3 may be connected to the second supporting member 52, thereby connecting the first spoke 11 and the second spoke 12 together.

In some embodiments, to increase the firmness of the first supporting member 51 and the second supporting member 52, the first supporting member 51 and the first spoke 11 may be integrated into one piece, and the second supporting member 52 and the spokes 12 may be integrated into one piece as well.

Referring to FIG. 1 to FIG. 9, the first supporting member 51 may include a first connecting portion 511 and a first reinforcing portion 512, the second supporting member 52 may include a second connecting portion 521 and a second reinforcing portion 522, where the first connecting portion 511 may be connected to the first reinforcing portion 512, and the second connecting portion 521 may be connected to the second reinforcing portion 522. Each first connecting portion 511 may correspond to a second connecting portion 521, and the first connecting portion 511 and the second connecting portion 521 may be connected to two ends of the roller 3 to secure the roller 3 on the outer annular surface of the annular structure. In the present embodiment, the first reinforcing portion 512 may be disposed between the first connecting portion 511 and the inner annular surface of the annular structure, and the second reinforcing portion 522 may be disposed at the second connecting portion 521 and the inner annular surface of the annular structure.

When the roller 3 is moving, the force on the first supporting member 51 closer to the roller 3 is greater, and the damage is more likely to occur. Therefore, the structure of the first supporting member 51 needs to be designed such that the strength of the first supporting member 51 may satisfy the movement requirement of the roller 3. In some embodiments, to increase the strength of the first supporting member 51, the first reinforcing portion 512 may protrude from the outer surface of the first spoke 11, and it may be connected to the outer surface of the first spoke 11. Further, the first reinforcing portion 512 may include a first side (not shown) and an oppositely disposed second side (not shown), where the first side may correspond to the first connecting portion 511. In one embodiment, to increase the strength of the first reinforcing portion 512, the width of the first reinforcing portion 512 may gradually decrease from the first side towards the second side. In one embodiment, to increase the strength of the first reinforcing portion 512, the height of the first reinforcing portion 512 may gradually decrease from the first side towards the second side.

In some embodiments, to facilitate the connection of the roller 3, the first connecting portion 511 may protrude from the first spoke 11. In the present embodiment, one end of the first connecting portion 511 may be connected to the corresponding first reinforcing portion 512, and the other end of the first connecting portion 511 may be connected to the roller 3. In addition, in the present embodiment, to increase the strength of the first connecting portion 511, the first connecting portion 511 may gradually decrease in width and/or height from the end that connects to the roller 3 to the end that connects to the first reinforcing portion 512.

Correspondingly, when the roller 3 is moving, the force on the second supporting member 52 closer to the roller 3 is greater, and the damage is more likely to occur. Therefore, the structure of the second supporting member 52 needs to be designed such that the strength of the second supporting member 52 may satisfy the movement requirement of the roller 3. In some embodiments, to increase the strength of the second supporting member 52, the second reinforcing portion 522 may protrude from the outer surface of the second spoke 12, and it may be connected to the outer surface of the second spoke 12. Further, the second reinforcing portion 522 may include a third side (not shown) and an oppositely disposed fourth side (not shown), where the third side may correspond to the second connecting portion 521. In one embodiment, to increase the strength of the second reinforcing portion 522, the width of the second reinforcing portion 522 may gradually decrease from the third side towards the fourth side. In one embodiment, to increase the strength of the second reinforcing portion 522, the height of the second reinforcing portion 522 may gradually decrease from the third side towards to the fourth side.

In some embodiments, to facilitate the connection of the roller 3, the second connecting portion 521 may protrude from the second spoke 12. In the present embodiment, one end of the second connecting portion 521 may be connected to the corresponding second reinforcing portion 522, and the other end of the second connecting portion 521 may be connected to the roller 3. In addition, in the present embodiment, to increase the strength of the second connecting portion 521, the second connecting portion 521 may gradually decrease in width and/or height from the end that connects to the roller 3 to the end that connects to the second reinforcing portion 522.

In some embodiments, to simplify the design and improve the strength of the first supporting member 51, the first connecting portion 511 and the first reinforcing portion 512 may be integrated into one piece. Further, to simplify the design and improve the strength of the second supporting member 52, the second connecting portion 521 and the second reinforcing portion 522 may be integrated into one piece as well.

In some embodiments, the first connecting portion 511 and the corresponding first reinforcing portion 512 may be integrated into one piece, and the second connecting portion 521 and the corresponding second reinforcing portion 522 may be integrated into one piece as well. With the characteristics of the impact force of the first supporting member 51 and the second supporting member 52 in mind, the strength and appearance of the first supporting member 51 and the second supporting member 52 may be optimized to enhance the strength and appearance of the first supporting member 51 and the second supporting member 52.

In the present embodiment, the first supporting member 51 and the second supporting member 52 are offset from each other along the circumferential direction of the Mecanum wheel 200 by a predetermined angle so the roller 3 disposed between the first supporting member 51 and the second supporting member 52 may be tilted. Further, the roller 3 may be obliquely disposed between the first spoke 11 and the second spoke 12, thereby increasing the flexibility and diversity of the movement of the roller 3. Furthermore, the predetermined angle may be at 15°, 30°, 45°, etc.

The first supporting member 51 and the second supporting member 52 may be disposed in pairs, and the first supporting member 51 and the second supporting member 52 disposed in pairs may be respectively connected to each end of the same roller 3 to secure the roller 3. Further, the number of the first supporting member 51 and the second supporting member 52 disposed in pairs may be determined based on the movement needs and connected to a corresponding number of rollers 3 to achieve flexibility and diversity of the movement.

In the embodiments of the present disclosure, the materials of the first spoke 11, the second spoke 12, the first hub 21, and the second hub 22 may be determined based on the manufacturing process, price, required strength, weight, etc. For example, the first spoke 11, the second spoke 12, the first hub 21, and the second hub 22 may be made of steel, alloy or carbon fiber. Of course, the materials of the first spoke 11, the second spoke 12, the first hub 21, and the second hub 22 may also be made from other materials. The material of the first spoke 11, the second spoke 12, the first hub 21, and the second hub 22 is not specifically limited in the embodiments of the present disclosure. In addition, the materials of the first supporting member 51 and the second supporting member 52 may also be determined based on the manufacturing process, price, required strength, weight, etc. For example, the first supporting member 51 and the second supporting member 52 may be made of steel, alloy, carbon fiber or other materials.

In one embodiment, to ensure the mechanical strength of the first spoke 11, the first hub 21, the first supporting member 51, the second spoke 12, the second hub 22 and the second supporting member 52, while reducing the weight of the Mecanum wheel 200, thereby reducing the noise of the Mecanum wheel 200 while it is in operation, when manufacturing the Mecanum wheel 200, the carbon fiber plate may be first molded into the first spoke 11, the first hub 21, the second spoke 12, and the second hub 22; then the first connecting portion 511 and the first reinforcing portion 512 of the first supporting member 51 may be formed by cutting the outer edge of the first spoke 11, and the second connecting portion 521 and the second reinforcing portion 522 of the second supporting member 52 may be formed by cutting the outer edge of the second spoke 12.

Referring to FIG. 1 to FIG. 9, the Mecanum wheel 200 may further include one or more fasteners 6. The fastener 6 may be disposed through the first connecting portion 511 and the second connecting portion 521 to secure the two sides of the roller 3. In some embodiments, in a pair of the first supporting member 51 and the second supporting member 52, the first connecting portion 511 and the second connecting portion 521 may each include a through hole. There may be two fasteners 6, and each fastener 6 may be connected to the roller 3 through the corresponding through hole. Hence, the roller 3 may be more securely mounted between the first supporting member 51 and the second supporting member 52. The present embodiment replaces the current technology of screwing through the roller 3 by using the fasteners 6 to secure both ends of the roller 3, thereby making the securing method simpler and more stable.

Further, the fastener 6 may be a screw, a nut or other type of fastener 6, such as a pin or the like.

In some embodiments, the Mecanum wheel 200 may further include a lubrication ring (not shown) that corresponds to the fastener 6, where the fastener 6 may be sleeved with the lubricating ring and connected to the roller 3 through the corresponding through hole. The lubrication ring may secure the corresponding fastener 6 to prevent the fasteners 6 from loosening when the rollers 3 is moving. Moreover, the lubricating ring may also seal the joint of the fastener 6 and the roller 3, thereby preventing external dust or other obstacles from entering the roller 3, which may hinder the movement of the roller 3.

Further, the roller 3 may include an axle (not shown) and a wheel body (not shown) that may be rotatably sleeved on the axle. To facilitate the connection of the roller 3, both ends of the axle may be exposed from the wheel body, and the fasteners 6 may be coupled to both ends of the axle.

In the present embodiment, the wheel body may be integrated into one piece and it may take the shape of a drum. The wheel body may be axially opened with a through hole for the axle to pass through. In some embodiments, the outer surface of the wheel may have a smooth surface. In some embodiments, the outer surface of the wheel may have treads to increase the friction of the roller 3 when it contacts the ground. Further, the treads may be a protrusion, a cavity, a line, a dot, or other patterns.

The material of the axle and the wheel body may be determined based on the need. In the present embodiment, in order to better support the wheel body, the strength of the axle may be greater than the strength of the wheel body. Further, the wheel body may be made of rubber or other materials such as plastic. Furthermore, the axle may be made of materials such as steel or alloy.

It should be noted that the Mecanum wheel 200 in the embodiments of the present disclosure may be used on a robot or other devices. Hereinafter, the above-described Mecanum wheel 200 will be used to a robot as an example for further explanation.

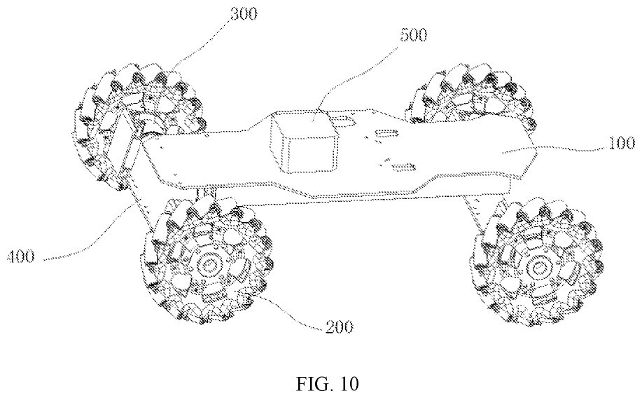

Referring to FIG. 10, an embodiment of the present disclosure provides a robot. The robot may include a body 100, a motor 300 to provide power, and the Mecanum wheel 200. Further, the Mecanum wheel 200 may be coupled to the body 100 to provide power to move the body 100. More specifically, the robot may further include a suspension 400, and the Mecanum wheel 200 may be coupled to the body 100 through the suspension 400.

In the present embodiment, the motor 300 may be housed in the receiving space 131 in the Mecanum wheel 200, so the structure of the robot may be more compact and the robot may be smaller. Of course, the motor 300 in the embodiments of the present disclosure may also be replaced with other power sources.

Further, the suspension 400 may be partially housed in the receiving space 131, thereby further making the structure of the robot more compact and the robot smaller.

In the present embodiment, the robot may further include a control device (not shown) mounted to the body 100. The control device may control the Mecanum wheel 200 to move in accordance with control commands so the body 100 may move based on a specified path. Further, the control device may be connected to a remote controller that may move the robot remotely. The control device may generate the control commands based on a user command sent by the remote controller, and transmit the control command to the motor 300, thereby controlling the motion of the Mecanum wheel 200.

In some embodiments, the robot may be an imaging robot, and the imaging robot may further include an imaging device 500 disposed on the body 100 to record images.

In some embodiments, the robot may be a sweeping robot.

In addition, the shape of the body 100 of the present embodiment may be any shape, such as a human shape or a vehicle shape, and it may also be determined based on the actual needs.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A Mecanum wheel comprising:
a spoke, a hub, and a plurality of rollers disposed on an outer edge of the spoke, the spoke including a receiving space to house the hub; the Mecanum wheel further includes a cushioning member, one end of the cushioning member being connected to the spoke, and the other end of the cushioning member being connected to the hub; in response to receiving an impact force, the cushioning member deforms to cause a displacement change of the hub relative to the spoke.

2. The Mecanum wheel of claim 1, wherein the cushioning member includes a plurality of elastic members disposed in a circumferential direction.

3. The Mecanum wheel of claim 2, wherein the elastics members each includes a curved portion that is configured to deform after the elastic members receive the impact force.

4. The Mecanum wheel of claim 2, wherein the elastic members each includes two or more curved portions, and the two or more curve portions are curved in opposite bending directions.

5. The Mecanum wheel of claim 2, wherein the plurality of elastic members are evenly distributed between the spoke and the hub.

6. The Mecanum wheel of claim 2, wherein the body of each elastic member is a sheet structure.

7. The Mecanum wheel of claim 6, wherein the plane of the sheet structure is parallel to the centerline of the hub, or the plane of the sheet structure is perpendicular to the centerline of the hub.

8. The Mecanum wheel of claim 6, wherein the elastic members each includes two or more layers that are disposed along the centerline direction of the hub.

9. The Mecanum wheel of claim 1, wherein the cushioning member, the hub, and the spoke are integrated into one piece.

10. The Mecanum wheel of claim 1, wherein the spoke includes a first spoke, and a second spoke disposed opposite to the first spoke; the hub includes a first hub and a second hub; the plurality of rollers are disposed between the first spoke and the second spoke; the second hub is recessed towards the first hub to form the receiving space such that the first hub and the second hub are both disposed on a same side of an intermediate plane equidistant from the first spoke and the second spoke; and the receiving space is configured to house a motor.

11. A robot comprising:
a body and a suspension,
wherein a Mecanum wheel is connected to the body through the suspension, and the Mecanum wheel comprises a spoke, a hub, and a plurality of rollers disposed on an outer edge of the spoke, the spoke including a receiving space to house the hub; the Mecanum wheel further includes a cushioning member, one end of the cushioning member being connected to the spoke, and the other end of the cushioning member being connected to the hub; in response to receiving an impact force, the cushioning member deforms to cause a displacement change of the hub relative to the spoke.

12. The robot of claim 11, wherein the cushioning member includes a plurality of elastic members disposed in a circumferential direction.

13. The robot of claim 12, wherein the elastics members each includes a curved portion that is configured to deform after the elastic members receive the impact force.

14. The robot of claim 12, wherein the elastic members each includes two or more curved portions, and the two or more curve portions are curved in opposite bending directions.

15. The robot of claim 12, wherein the plurality of elastic members are evenly distributed between the spoke and the hub.

16. The robot of claim 12, wherein the body of each elastic member is a sheet structure.

17. The robot of claim 16, wherein the plane of the sheet structure is parallel to the centerline of the hub, or the plane of the sheet structure is perpendicular to the centerline of the hub.

18. The robot of claim 16, wherein the elastic members each includes two or more layers that are disposed along the centerline direction of the hub.

19. The robot of claim 11, wherein the cushioning member, the hub, and the spoke are integrated into one piece.

20. The robot of claim 11, wherein the spoke includes a first spoke, and a second spoke disposed opposite the first spoke; the hub includes a first hub and a second hub; the plurality of rollers are disposed between the first spoke and the second spoke; the second hub is recessed towards the first hub to form the receiving space such that the first hub and the second hub are both disposed on a same side of an intermediate plane equidistant from the first spoke and the second spoke; and the receiving space is configured to house a motor.
